(19) United States
(12) Patent Application Publication
(10) Pub. No.: US 2017/0000078 A1
(43) Pub. Date: Jan. 5, 2017

(54) URINAL PADS FOR PETS WITH ANNULAR INSTANT ABSORPTION RINGS

(71) Applicant: Jiangsu Zhongheng Pet Articles Joint-Stock Co., Ltd., Jiangsu (CN)

(72) Inventor: Qiu Bin, Jiangsu (CN)

(73) Assignee: Jiangsu Zhongheng Pet Articles Joint-Stock Co., Lt d., Jiangsu (CN)

(21) Appl. No.: 15/201,342

(22) Filed: Jul. 1, 2016

(30) Foreign Application Priority Data
Jul. 1, 2015 (CN) 201520464367.9

(51) Int. Cl. A01K 1/01; B32B 5/02; B32B 27/06; A01K 1/015

(52) U.S. Cl. CPC A01K 1/0107; A01K 1/0157; A01K 1/0152; B32B 5/022; B32B 27/06

(57) ABSTRACT

A urinal pad for pets with annular instant absorption rings, which includes a urinal pad main body with a layered structure. The urinal pad main body includes a non-woven fabric cover layer and an absorption layer, wherein a plurality of concentric annular instant absorption rings are disposed on the absorption layer. The plurality of concentric annular instant absorption rings disposed on the absorption layer are at equal intervals. The plurality of concentric annular instant absorption rings are made of a polymer absorbent resin.

### CROSS-REFERENCE TO RELATED APPLICATIONS

This Application claims the priority of Chinese Patent Application No. 201520464367.9, filed on Jul. 1, 2015, the disclosure of which is incorporated by reference in its entirety.

### TECHNICAL FIELD

The present invention relates to pet supplies, and particularly relates to a urinal pad for pets with annular instant absorption rings.

### BACKGROUND ART

At present, with the improvement of people's living standards, pets, such as cats and dogs, began to enter people's life and have been becoming more and more important. But in daily lives, it is considerably troublesome to treat excrement of pets, and owners need to spend considerable efforts to solve this problem. In order to protect the environment, also make the habitation places of pets more comfortable, meet the animal rights demands of pets and simultaneously reduce the tedious labors of people to clean pets, a substantial number of people have been using urinal pads for pets while raising pets. A typical existing urinal pad for pets comprises a non-woven fabric cover layer, an absorption layer formed by mixing wood pulp, PP fiber and super absorbent molecules, is disposed under the non-woven fabric surface cover layer, and a bottom leakage-proof layer made of a PE film is disposed on the outside surface of the absorption layer. The absorption layer of such a urinal pad for pets is located in the center region of the urinal pad for pets, when there is a large volume of urine and there is not enough time to absorb the urine of pets, urine will spread along with the surface of the urinal pad, leading to leakage.

### SUMMARY OF THE INVENTION

An object of the present invention is to provide urinal pads for pets with annular instant absorption layers, in order to solve the above problem.

Objects of the present invention may be realized in the following manners:

A urinal pad for pets with an absorption layer having one or more annular instant (fast) absorption rings (i.e., concentric annuar layers) is characterized by comprising a urinal pad main body that has a layered structure. The urinal pad main body from sequentially comprises a non-woven fabric cover layer and an absorption layer. On top of the absorption layer are a plurality of concentric annular instant absorption (i.e., fast absorption) rings with raised heights (these rings are higher than the tope surface of the absorption layer because they are disposed on the absorption layer). The plurality of concentric annular instant absorption rings (i.e., concentric annular layers) may be arranged on the absorption layer at equal intervals.

Wherein the annular instant absorption rings are made of a polymer absorbent resin. Various water absorbing polymers (such as superabsorbent polymers, hydrogels) are well known in the art and have been used in similar products such as diapers and ault hygiene products. See, e.g., https://en.wikipedia.org/wiki/Superabsorbent_polymer One skilled in the art would appreciate that any of such polymers or the like may be used with embodiments of the invention. Due to the superabsorbent properties of these materials, the absorption will be very fast (i.e., fast absorbing or instant absorbing). Thus, “instant absorption,” “fast absorption,” and “superabsorption” may be used interchangeably herein.

Wherein the water absorbing capacity of the annular instant absorption rings is higher than that of absorption layer.

Wherein the outer edge of the non-woven fabric cover layer overlaps (aligns) with the outer edge of the absorption layer. That is, in preferred embodiments, the cover layer and the absorption layer are of the same size (i.e., same width and length) and are stack in the layered structure such that the edges are aligned.

Embodiments of the present invention have one or more of the following beneficial effects:
1) The plurality of annular instant absorption rings disposed at equal intervals are raised on the absorption layer (i.e., thicker) so that the annular instant absorption rings play a inter-zone barrier effects when there is not enough time to absorb all the urine of pets, and the urine is circumscribed on the absorption layer to prevent the urine from spreading along with the surface of the urinal pad.
2) Only a few annular instant absorption rings with raised heights are on the absorption layer, so that the water absorbing capacity of the urinal pad can be improved without excessively increasing the product costs.

### BRIEF DESCRIPTION OF THE DRAWINGS

FIG. 1 shows a structural diagram of an embodiment of the present invention.

FIG. 2 shows a sectional view along the A-A section as shown in FIG. 1.

### DETAILED DESCRIPTION

The present invention will be further illustrated below with specific examples and the attached drawings.

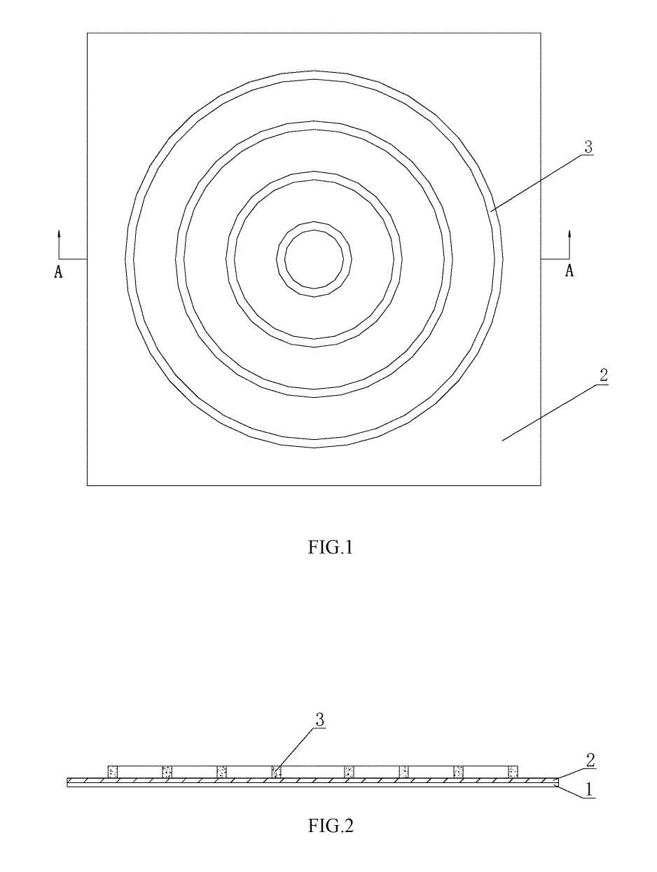

As shown in FIG. 1 and FIG. 2, a urinal pad for pets with annular instant absorption rings comprises a urinal pad main body having a layered structure. The urinal pad main body sequentially comprises, from top to bottom, a non-woven fabric cover layer 1 and an absorption layer 2, wherein the outer edge of the non-woven fabric cover layer 1 overlaps/aligns with that of the absorption layer 2. A plurality of concentric annular instant absorption rings 3 with raised heights are arranged on the absorption layer 2, preferably at equal intervals. The water absorbing capacity of the annular instant absorption rings 3 is higher than that of the absorption layer 2. The annular instant absorption rings 3 (i.e., concentric annular layers) may be made of a polymer absorbent resin. Such a structure can improve the water absorbing capacity of the urinal pad, and in contrast to using a polymer absorbent resin to substitute for an entire absorption layer, the use of the annular instant absorption rings will not excessively increase the product cost.

During use, urine of pets is generally concentrated in the middle of the urinal pad, and when excessive urine accumulates, the annular instant absorption rings 3 will play a role in rapidly absorbing the urine and also has the effect of stopping the urine from spreading. The urine of pets is limited by the annular instant absorption rings 3 to effectively prevent the urine from spreading along the surface of the urinal pad so as to avoid leakage. With such a structure, only a plurality of instant absorption rings 3 are disposed on the absorption layer 2. The increases in product costs would be minimal, but the water absorbing capacity of the urinal pad can be greatly improved.

What is claimed is:

1. A urinal pad for pets with annular instant absorption rings, wherein the urinal pad comprises a urinal pad main body with a layered structure, wherein the urinal pad main body comprises a non-woven fabric cover layer and an absorption layer, wherein a plurality of concentric annular instant absorption rings are disposed on the absorption layer.

2. The urinal pad for pets with annular instant absorption rings according to claim 1, wherein the plurality of concentric annular instant absorption rings disposed on the absorption layer are at equal intervals.

3. The urinal pad for pets with annular instant absorption rings according to claim 1, wherein the plurality of concentric annular instant absorption rings are made of a polymer absorbent resin.

4. The urinal pad for pets with annular instant absorption rings according to claim 1, wherein a water absorbing capacity of the plurality of concentric annular instant absorption rings is higher than that of the absorption layer.

5. The urinal pad for pets with annular instant absorption rings according to claim 1, wherein an outer edge of the non-woven fabric cover layer aligns with that of the absorption layer.
